(19) United States
(12) Patent Application Publication
(10) Pub. No.: US 2025/0153476 A1
(43) Pub. Date: May 15, 2025

(54) Interior Component Having a Carrier Element and an Upper Textile Layer

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Maike DIECKMANN, Landshut (DE); Johann GASSLHUBER, Buch am Erlbach (DE)

(21) Appl. No.: 18/941,453

(22) Filed: Nov. 8, 2024

(30) Foreign Application Priority Data
Nov. 10, 2023 (DE) 10 2023 131 240.5

(51) Int. Cl. B32B 27/12; B32B 5/02

(52) U.S. Cl. CPC B32B 27/12; B32B 5/02; B32B 2250/24; B32B 2262/02; B32B 2605/003

(57) ABSTRACT

An interior component of a motor vehicle includes a carrier element and an upper textile layer. The upper textile layer has fibers and the carrier element and the fibers of the upper textile layer are formed from a same base material. Thus, an interior component is provided where reuse of the materials and quality of the reused materials is optimized.

### CROSS REFERENCE TO RELATED APPLICATION

This application claims priority under 35 U.S.C. § 119 from German Patent Application No. DE 10 2023 131 240.5, filed Nov. 10, 2023, the entire disclosure of which is herein expressly incorporated by reference.

### BACKGROUND AND SUMMARY

The invention relates to an interior component having a carrier element and an upper textile layer.

In the prior art, polyester knits are frequently used as an upper layer of an interior component. The polyester knit material is cohesively laminated here onto a carrier material of the interior component, usually consisting of polypropylene.

In the context of a circular economy, circular use of materials of interior components of a motor vehicle is increasing in significance for reasons of sustainability.

However, reuse at the end of the component's lifetime is currently not possible in a single-substance process, since single-substance separation of the materials is not feasible.

It is therefore an object of the invention to overcome the aforementioned disadvantages and to provide an interior component where reuse of the materials and quality of the reused materials is optimized.

The basic idea of the invention is that the upper textile layer of an interior component, especially a knit, is manufactured from the same base polymer from the same polymer family as a carrier element of the interior component. Accordingly, the textile fibers of the upper textile layer are from the same polymer family as the carrier element onto which the upper layer has been laminated. In this way, the use of the interior component has been optimized since there is no need to separate the materials of the components of the interior component, and the result is an improved quality of the materials reused.

What is therefore provided in accordance with the invention is an interior component, in particular of a motor vehicle, having a carrier element and an upper textile layer, in which the carrier element and the upper textile layer, especially the fibers of the upper textile layer, are formed essentially from the same base material.

In an advantageous execution variant, the carrier element and the upper textile layer are formed from the same base polymer from the same polymer family.

In one working example of the invention, the carrier element and the upper textile layer are formed from the same monomaterial.

Moreover, the upper textile layer, in one execution variant, has been laminated onto the carrier element.

In a preferred embodiment of the invention, the carrier element and the upper textile layer are formed from the same material.

In a further advantageous variant, according to the invention, the upper textile layer is disposed partially atop the carrier element.

In one execution variant, the interior component of the invention is designed such that there is an interlayer which is disposed between the carrier element and the upper textile layer and is formed essentially from the same base material, especially from the same material as the carrier element and the upper textile layer.

Another favorable execution is one in which the essentially identical base material is polypropylene and/or polycarbonate/acrylonitrile-butadiene-styrene (PC/ABS) and/or polypropylene natural fiber (PP-MF) and/or thermoplastic olefins (TPO) and/or polyester and/or polyethylene terephthalate (PET).

In one working example of the invention, the interior component is a cockpit panel or an instrument panel or a glovebox or a door liner or a column lining or a center console or a roof lining or a seatback lining of a motor vehicle. However, there are also conceivable embodiments in which the interior component is used in airplanes or trains, or buses.

This is also conceivable for all other kinds of lining parts and functional parts.

The features disclosed above can be combined as desired, insofar as this is technically possible and they are not mutually exclusive.

Other advantageous developments of the invention are characterized in the dependent claims or are illustrated in more detail below together with the description of the preferred embodiment of the invention on the basis of the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a section view of an interior component having a carrier element and an upper textile layer; and

FIG. 2 is a section view of an interior component having a carrier element, an upper textile layer and an interlayer.

### DETAILED DESCRIPTION OF THE DRAWINGS

The figures are illustrative and schematic. Identical reference designations in the figures indicate identical functional and/or structural features.

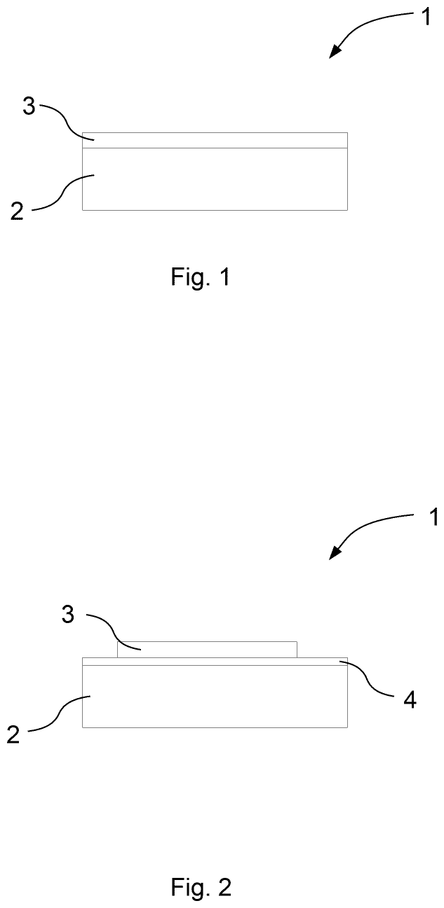

FIG. 1 shows a section view of an interior component 1 having a carrier element 2 and an upper textile layer 3. The carrier element 2 and the upper textile layer 3, especially the fibers of the upper textile 3, are formed essentially from the same base material. The upper textile layer 3 has been laminated onto the carrier element 2.

In the execution shown in FIG. 1, the carrier element 2 and the upper textile layer 3 have been formed from the same base polymer made from the same material. Accordingly, the carrier element 2 and the upper textile layer 3 have been formed from the same polymer family. In the present case, from the same monomaterial. The essentially identical base material is polypropylene and/or polycarbonate/acrylonitrile-butadiene-styrene (PC/ABS) and/or polypropylene natural fiber (PP-MF) and/or thermoplastic olefins (TPO) and/or polyester and/or polyethylene (PET).

FIG. 2 shows a section view of an interior component 1 having a carrier element 2, an upper textile layer 3 and an interlayer 4. Since the interior component 1 shown in FIG. 2 has the same features as the interior component 1 shown in FIG. 1, all that are addressed hereinafter are different or additional features.

In the interior component 1 shown in FIG. 2, there is an interlayer 4 which is disposed between the carrier element 2 and the upper textile layer 3 and is formed from the same material. Moreover, the upper textile 3 is disposed partially atop the carrier element 2.

In terms of its execution, the invention is not limited to the preferred working examples specified above. Instead, there is a number of conceivable variants that make use of the solution presented even in fundamentally different types of execution.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An interior component of a motor vehicle, comprising:
a carrier element; and
an upper textile layer;
wherein the carrier element and fibers of the upper textile layer are formed from a same base material.

2. The interior component according to claim 1, wherein the carrier element and the upper textile layer are formed from a same base polymer from a same polymer family.

3. The interior component according to claim 1, wherein the carrier element and the upper textile layer are formed from a same monomaterial.

4. The interior component according to claim 1, wherein the carrier element and the upper textile layer are formed from a same material.

5. The interior component according to claim 1, wherein the upper textile layer is laminated onto the carrier element.

6. The interior component according to claim 1, wherein the upper textile layer is disposed partially atop the carrier element.

7. The interior component according to claim 1, further comprising an interlayer disposed between the carrier element and the upper textile layer, wherein the interlayer is formed from the same base material.

8. The interior component according to claim 1, wherein the same base material is polypropylene and/or polycarbonate/acrylonitrile-butadiene-styrene (PC/ABS) and/or polypropylene natural fiber (PP-MF) and/or thermoplastic olefins (TPO) and/or polyester and/or polyethylene terephthalate (PET).
